(19) United States
(12) Patent Application Publication
(10) Pub. No.: US 2005/0070293 A1
(43) Pub. Date: Mar. 31, 2005

(54) Communication terminal and base station selection method

(75) Inventors: Hiroshi Tsukiji, Kanagawa (JP); Kenji Kono, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/946,368

(22) Filed: Sep. 21, 2004

(30) Foreign Application Priority Data
Sep. 24, 2003 (JP) P.2003-331567
Oct. 30, 2003 (JP) P.2003-369978

(51) Int. Cl. H04Q 7/20

(52) U.S. Cl. 455/452.1; 455/436

(57) ABSTRACT

A communication unit adapted to the EV-DO standard communicates with a base station. An acquisition unit acquires the number of communication terminals in communication with the base station. A derivation unit measures the CIR from the received pilot signal to derive a DRC value corresponding to the measurement result. A storage unit stores the number of communication terminals obtained from the acquisition unit and the CRC value derived from the derivation unit. A calculation unit calculates an estimated communication rate based on the maximum transmission rate with the base station corresponding to the DRC value, the maximum DRC value, the derived DRC value from the derivation unit, and the number of communication terminals. A comparison unit selects a base station having a high estimated communication rate as a base station to communicate.

### BACKGROUND OF THE INVENTION

1. Field of the Invention

The invention relates to a communication terminal that selects a base station to be communicated among a plurality of base stations and to a base station selection method.

Further, the invention relates to a communication terminal that performs hand-over (changing base station) during executing application (e.g., services such as downloading or streaming video data) to prevent image and voice data from being degraded.

2. Description of the Related Art

Recently, with the advancements in the technology related to communication terminal, the communication terminal such as a mobile telephone can typically transmit and receive data such as image and video data in addition to voice communication service. Applications that provide services such as downloading or streaming video data are beginning to be made available to mobile telephones. With the variety of applications, mobile communication networks usually require transmitting more amounts of data on the downlink. To meet this needs, a high-speed communication network has been proposed which uses a “cdma2000 1× EV-DO (1× Evolution Data Optimized)” (hereinafter, referred to as “EV-DO”) system that improves the transmission efficiency on the downlink or from base stations to communication terminals.

The EV-DO is a standard that further optimizes cdma2000 1× (hereinafter, also referred to as “1×”), which expands cdmaOne standard to correspond to the third generation standard, in data communication to make the transmission rates higher.

For the EV-DO, a wireless interface for the uplink from a wireless communication terminal (access terminal in the EV-DO) to a base station (access network ion the EV-DO) has the substantially same configuration as that of cdma2000 1×. A wireless interface for the downlink from the base station to the wireless communication terminal has also the same configuration as that of cdma2000 1× in respect of that a bandwidth is specified in 1.23 MHz, while they are quite different in respect of modulation and multiplexing methods. As the modulation system, the cdma2000 1× uses QPSK and HPSK, while the EV-DO selects one among QPSK, 8-PSK, and 16 QAM depending on the downlink receiving status of the wireless communication terminal. As a result, when the receiving status is good, a transmission rate with low error-rate but high-speed is used, while when the receiving status is bad, a transmission rate with low-speed but high error-rate is used.

Further, as a multiplexing method of performing communication from one base station to a plurality of wireless communication terminals at the same time, not Code Division Multiple Access (CDMA) for use in cdmaOne and cdma2000 1× but Time Division Multiple Access (TDMA) is used. In TDMA, time is divided by 1/600 second, and the base station communicates with only one wireless communication terminal at one unit time, and the base station changes the wireless communication terminal to be communicated for every unit time in order to perform communication with the plurality of wireless communication terminals.

The wireless communication terminal measures a Carrier to Interference Ratio (hereinafter, referred to as “CIR”) of a pilot signal in order to obtain the receiving status of the downlink from the base station. Further, the wireless communication terminal estimates the receiving status at the next receiving timing based on the CIR change, and informs the base station of “the maximum transmission rate that can be received below a predetermined error rate” as a Data Rate Control bit (hereinafter, referred to as “DRC”). The predetermined error rate is generally set to about several percentages, though depending upon the system design. The base station receives the DRC from the plurality of wireless communication terminals to determine which wireless communication terminal is communicated with. Further, the base station basically uses the transmission rate as high as possible for each wireless communication terminal on the basis of the DRC from the wireless communication terminals.

In the EV-DO standard, the maximum 2.4 Mbps of transmission rate is possible for the downlink each sector. However, this transmission rate is typically the a total of the amount of data communication with the plurality of wireless communication terminals that one base station is connected to in one frequency band, at one of a plurality of sectors. A plurality of frequency bands is used, the higher transmission rate is.

JP-A-2002-300644 is referred to as a related art.

In general, the wireless communication terminals using the EV-DO standard derives the DRC for a plurality of base stations, and selects a base station having the highest transmission rate that corresponds to the DRC as a base station to be communicated. On the other hand, the base station using the EV-DO standard connects the plurality of wireless communication terminals by using TDMA. Therefore, even when the transmission rate that corresponds to the DRC is high, the actual data transmission rate is lowered if the number of connected wireless terminals is large. That is, the number of wireless communication terminal connected to a base station needs to be considered in order to increase the data transmission rate of the wireless terminals.

A high-speed packet communication between a base station and a wireless communication terminal using the 1× EV-DO system will now be described. The packet used in the 1× EV-DO system is configured such that a header including pilot signal and control information is arranged at the beginning of data in which data to be sent to each user are time-division-multiplexed. The control information includes allocation information that represents allocation of communication resources in each communication terminal.

First, the base station sends a packet including the pilot signal to each communication terminal within a coverage area of the base station. Each communication terminal measures downlink quality (e.g., CIR) based on the pilot signal included in the received signal. In each communication terminal, a table is stored, which represents the correspondence between the downlink quality and the optimum communication mode when the packet is communicated with the downlink quality. Each communication terminal refers to the table to select a communication mode with which a high-speed packet communication can be performed most efficiently over the measured link quality. The term “communication mode” is based on a slot frame into which transmitting data can be allocated, a coded rate of the transmitting data, a modulation system and a diffusion coefficient, respectively. Further, each communication terminal transmits to the base station a signal representing the selected communication mode (DRC). Other communication terminals in the coverage area of the base station transmit the DRC to the base station in the same manner.

The base station refers to the transmitted DRC from each communication terminal to allocate communication resources to a communication terminal having the better link quality. Thus, since the communication terminal having the better link quality transmits data with the higher transmission rate, the transmission time can be reduced. On the other hand, since the communication terminal having the worse link quality transmits data with the lower transmission rate, the error resilience can be increased. The determination of allocating a transmitting slot according to the link quality in the base station using the 1× EV-DO system is called “scheduling”.

The base station allocates a slot to the transmitting data, according to the allocation of the communication resources, and performs a coding process, a modulation process and a diffusion process to produce transmission frames by time-division-multiplexing the transmission data for each communication terminal to transmit the transmission frames to each communication terminal. At the header in the beginning of the transmission frame, control information (allocation information) that represents allocation of the communication resources to each communication terminal is inserted. The communication terminal refers to the allocation information to acknowledge a communication mode so that the communication terminal demodulates data transmitted for the communication terminal. In the conventional 1× EV-DO system, the communication resources are first allocated to the communication terminal having the better link quality, so that the data transmission efficiency is increased in the overall system.

Examples of services that use the high-speed wireless packet communication network as described above are video streaming services such as VOD or live streaming. Generally, in the video streaming service, a video streaming server transmits contents data to a video client through a transmission line. The video streaming server has a coding unit, a transmission unit and a transmission control unit. The coding unit converts the video source into, for example, MPEG-4 streams to send to the transmission unit. The transmission unit segments the received stream data with conforming to the lower transport protocol, and sends the segmented stream data to the transmission line. The transmission control unit starts or stops the transmission, controls the transmission rate, and the like.

Further, Real-Time Transport Protocol (RTP) specified to be RFC1889 as a data transport protocol and RTP Control Protocol (RTCP) as a control protocol of RTP are used to ensure a real-time play of the stream data. The video streaming server can predict the receipt rate at the client side by using the RTCP information. Thus, the streaming is performed by using a variable rate control method with which the transmission rate of the server is controlled. In particular, when the video streaming service is implemented in the 1× EV-DO system that has a large variation in the transmission bandwidth, the variable rate streaming is effective in that the transmission rate of the server is changed and data is transmitted based on the changed bandwidth.

In the communication system as described above, a hand-over control in case that the communication terminal moves toward the coverage of the second base station while still in communication with the first base station, as shown in FIG. 10, will now be described.

The communication terminal in communication with the first base station receives signals from a plurality of connectable base stations (second base station in FIG. 10) to inform the signal quality to the network. The base station (switching center) responsible for the link management instructs to transmit the same signals transmitted from the first base station to the second base station that the communication terminal is about to connect, in accordance with the situation informed from the communication terminal.

The communication terminal receives the same signals received from two base stations to compare the qualities of two signals. When the signal quality from the second base station is better than that from the first base station, the communication terminal changes (hand-over) the connected base station from the first base station to the second base station to keep communication.

The 1× EV-DO system is disclosed in 2002-353876.

Assume that the communication terminal that uses the video streaming service from a variable-rate streaming server (video streaming server) in the described 1× EV-DO network moves from the area of the first base station in communication toward the area of the second base station, for example.

In this case, when the number of communication terminals that are in the coverage area of the second base station in communication with the second base station are more than the number of communication terminals that communicate with the first base station, the transmission rate between the second base station and the communication terminal that performing hand-over decreases after the hand-over due to the above scheduling in the base station if the hand-over is performed based on the receiving signal quality. When the transmission rate is degraded, the transmission rate of the streaming server (video streaming server) and the transport rate of the wireless zone comes to be different. Therefore, since a data retention in the base station and a data delay in the communication terminal occurs, the quality of video contents being played becomes degraded.

### SUMMARY OF THE INVENTION

The object of the invention is to provide a base station selection method in consideration of the number of terminals connected to the base station and a communication terminal using the same.

The invention provides a communication terminal having: a derivation portion that derives estimated transmission rate with each of a plurality of base stations which are available to communicate with the communication terminal, based on signals transmitted from the base stations; a reception portion that receives the number of terminals being connected to each base station from any of the base stations; and a control portion that selects a base station to communicate among the base stations based on the derived estimated transmission rate and the received number of terminals.

Thus, since the number of terminals and the estimated transmission rate are used for the selection of the base station to communicate, the base station whose transmission rate with the base station is substantially high can be selected.

The number of terminals received by the reception includes the number of terminals may be in communication with each of the base stations. The number of terminals received by the reception portion may further include the number of terminals in an idle state for each of the base stations.

The control portion may, for each of the base stations, calculates the number of terminals in execution based on the received number of terminals and the derived estimated transmission rate, and then calculates a transmission rate by the number of terminals in execution, and compares each of the calculated transmission rates to select a base station corresponding to the highest transmission rate as a base station to communicate.

The control portion may select a base station to communicate among the base stations in a case of transmitting signals. The communication terminal may further have a storage portion that stores the derived estimated transmission rate and the received number of terminals, wherein the control portion selects a base station to communicate among the base station, based on the estimated transmission rate and the number of terminals stored in the storage portion.

The invention also provides a base station selection method having the steps of: deriving estimated transmission rate with each of a plurality of base stations which are available to communicate with the communication terminal, based on signals transmitted from the base stations; receiving the number of terminals being connected to each base station from any of the base stations; and selecting a base station to communicate among the base stations based on the derived estimated transmission rate and the received number of terminals.

Any combination of above elements, methods apparatuses, systems, storage media, and computer programs fall into the scope of the invention.

According to the invention, the base station selection method in consideration of the number of terminals connected to the base station and the communication terminal using the same can be provided.

The object of the invention is to provide a communication terminal that performs hand-over during executing application (e.g., services such as downloading or streaming video data) in the communication terminal to prevent image and sound contents from being degraded.

The invention also provides a communication terminal, which changes a base station to communicate by hand-over between a plurality of base stations, having: a measuring portion that measures quality of communication with a base station in communication and quality of communication with a base station to be a hand-over candidate; a reception portion that receives the number of terminals being connected to the base station in communication and the number of terminals being connected to the base station to be the hand-over candidate; and a control portion that determines whether or not a hand-over is needed or a base station to be a hand-over target among the base station to be the hand-over candidate, based on the measured communication qualities and the received number of terminals.

The control portion may calculate a transmission rate with each of the base stations based on the received number of terminals, compare the calculated transmission rate with each base station, and determine whether or not hand-over is needed or a base station to be a hand-over target according to a comparison result.

The control portion may determine whether or not a hand-over is needed or a base station to be a hand-over target, based on the measured communication qualities, the received number of terminals and a type of application in execution.

The communication terminal of the invention measures quality of communication with a base station in communication and quality of communication with a base station to be a hand-over candidate, and acquires the number of terminals being connected to the base station in communication and the number of terminals being connected to the base station to be the hand-over candidate. Further, the communication terminal determines whether or not a hand-over is needed or a base station to be a hand-over target among the base station to be the hand-over candidate, based on the measured communication quality and the acquired number of terminals.

Therefore, a busy state of the wireless link to be handed-over can be estimated before performing hand-over, thereby avoiding a degradation of video data or sound data in the application caused by the reduced effective rate after the hand-over.

Further, the communication terminal calculates a transmission rate with each base station based on the acquired number of terminals to determines whether or not hand-over is needed and a base station to be a hand-over target based on the calculation result.

Therefore, the transmission rate of the wireless line to be handed-over can be estimated before performing hand-over, thereby avoiding a degradation of video data or sound data in the application caused by the reduced effective rate after the hand-over.

Further, the communication terminal determines whether or not a hand-over is needed or a base station to be a hand-over target, based on the measured communication quality, the acquired number of terminals and a type of application in execution.

Therefore, based on the type of application as well as the busy state of the wireless line to be handed-over, whether or not the hand-over control is need is determined and a base station to be a target to hand-over can be selected.

### BRIEF DESCRIPTION OF THE DRAWINGS

FIG. 1 is a diagram showing a configuration of a communication system of a first embodiment;

FIG. 2 is a diagram showing a correspondence between a transmission rate and DRC used in the derivation unit of FIG. 1;

FIG. 3 is a flow chart illustrating a hand-off processing illustrated in FIG. 1;

FIG. 4 is a flow chart illustrating a TDMA processing illustrated in FIG. 1;

FIG. 5 is a flow chart illustrating a selection process of a base station illustrated in FIG. 1;

FIG. 6 is a flow chart illustrating a handoff processing illustrated in FIG. 1;

FIG. 7 is a diagram showing an exemplary configuration of a communication system for use in a communication terminal of a second embodiment;

FIG. 8 is a flow chart illustrating a hand-over processing in the communication terminal;

FIG. 9 is a block diagram showing an exemplary configuration of the communication terminal; and

FIG. 10 is a diagram for illustrating the conventional hand-over control.

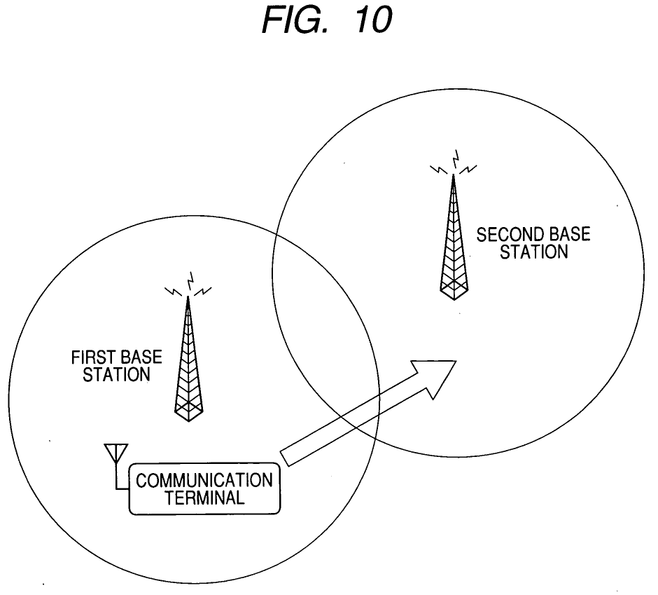

### DETAILED DESCRIPTION OF THE PREFERRED EMBODIMENTS

[First Embodiment]

A base station selection method and a communication terminal using the same according to the invention will be briefly described.

A first embodiment of the invention is directed to a communication terminal (access terminal in the EV-DO) for selecting a base station (access network ion the EV-DO) to be communicated in the environment where a plurality of base stations are available to communicate. The communication terminal is adapted to the EV-DO standard. The communication terminal of the embodiment receives pilot signals from the plurality of base stations to derive DRC corresponding to each base station. Further, the communication terminal acquires the number of terminals in communication with each base stations. Moreover, the communication terminal calculates estimated transmission rate (data rate of forward link channel) corresponding to each of the plurality of base stations based on the DRC and the number of terminals.

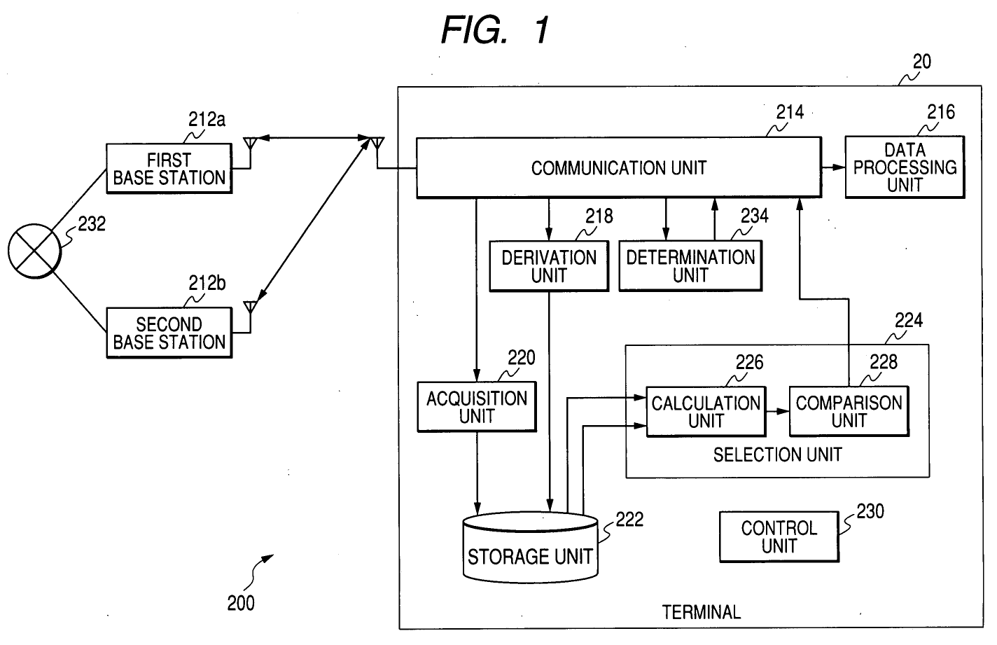

FIG. 1 shows a configuration of a communication system 200 related to the first embodiment of the invention. The communication system 200 has a terminal 20, base stations 212 including a first base station and a second base station 212b, and a network 232. The terminal 20 has a communication unit 214, a data processing unit 216, a derivation unit 218, an acquisition unit 220, a storage unit 222, a selection unit 224, a control unit 230 and a determination unit 234. The selection unit 224 includes a calculation unit 226 and a comparison unit 228.

The base station 212 is adapted to the EV-DO standard and can communicate with a plurality of terminals 20. Two base stations 212 are shown in FIG. 1, more base stations 212 may be connected to the network 232. Communication apparatuses such as a server having predetermined function like a WWW server are connected to the network 232.

The communication unit 214, which is adapted to the EV-DO standard, communicates with the base station 212. The communication unit 214 has an RF circuit, a frequency converting circuit, an amplification circuit, a modulation circuit and a demodulation circuit. Data transmitted or to be transmitted between the base station 212 and the communication unit 214 is processed in the data processing unit 216. That is, the data processing unit 216 receives requests from a user and provides some information based on the received information to the user through a predetermined interface.

While the terminal 20 is in an idle state, a base station 212 currently in an idle state is set as “Active Set,” and a base station having somewhat strong pilot signal among other base stations 212 in the vicinity of the base station 212 is set as “Neighbor Set.” The determination unit 234 determines whether transition is conducted from “Neighbor Set” to “Active Set” or not, that is, determines whether “Idle Hand-off” is conducted or not. On the other hand, while the terminal 20 is a connected state, a base station 212 currently in a connected state or having a pilot signal strong enough to enable Hand-off is set as “Active Set,” and a base station 212 having the lower pilot signal than the above is set as “Neighbor Set.” The determination unit 234 determines whether transition is conducted from “Neighbor Set” to “Active Set” or not.

The acquisition unit 220 receives signals including information about the number of terminals 20 in communicating with base stations 212 from the base stations 212, and acquires information about the number of terminals 20 in communicating with the base stations 212 from the signals. The signal including information about the number of terminals 20 for communicating with the base station 212 is transmitted at the timing described below. The number of terminals 20 included in the signal transmitted from the base station 212 may further include the number of terminals 20 in the idle state for the base stations 212. The acquisition unit 220 receives each of the signals from the plurality of base stations 212, as illustrated in the drawings.

The derivation unit 218 measures CIR based on the received pilot signal to derive DRC corresponding to the CIR of the measurement result. The derivation unit 218 receives each of the pilot signals from the plurality of base stations 212 to derive DRC corresponding to each base station 212.

The storage unit 222 stores the number of terminals 20 obtained by the acquisition unit 220 and the DRC value derived by the derivation unit 218.

The calculation unit 226 calculates an estimated communication rate as follows, based on a maximum transfer rate with the base station 212 corresponding to the DRC value, the maximum value of the DRC, the DRC value derived by the derivation unit 218, and the number of terminals 20.

Estimated communication rate=(Maximum transmission rate with the base station 212 corresponding to the DRC value)/(the number of terminals 20×(the maximum value of the DRC/the DRC derived by the derivation unit 218))

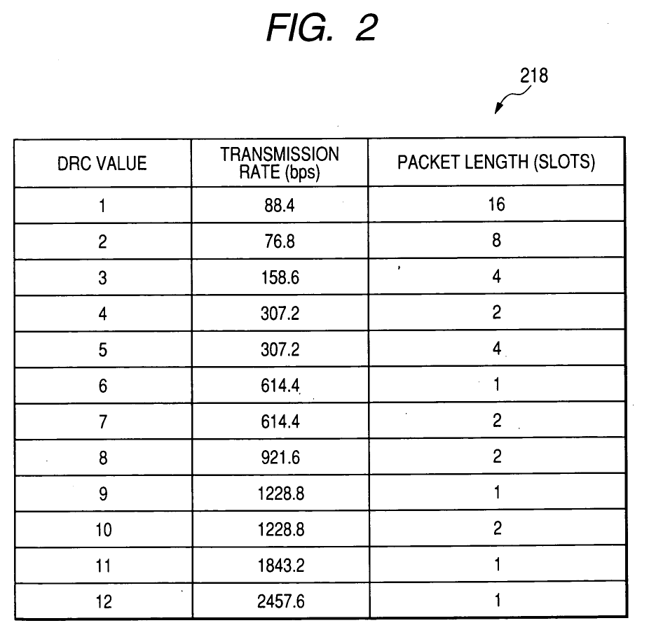

FIG. 2 illustrates a correspondence between the transmission rate and the DRC used in the derivation unit 218. As illustrated in FIG. 2, the DRC values correspond to the predetermined transmission rates, such that the larger the DRC is, the higher the transmission rate is. An example of calculating the estimated communication rate will be described below. The maximum value of the DRC is “12” as shown in FIG. 2. When the number of terminals obtained by the acquisition unit 220 is “3” and the DRC derived by the derivation unit 218 is “6”, that is, the maximum transmission rate with the base stations 212 corresponding to the DRC is “614.4 (kbps)”, the estimated communication rate is “102.4 (kbps)”. When the DRC derived by the derivation unit 218 is “9” and the maximum transmission rate with the base stations 212 corresponding to the DRC is “1228.8 (kbps)”, the estimated communication rate is “307.2 (kbps)”. When the DRC derived by the derivation unit 218 is “12” and the maximum transmission rate with the base stations 212 corresponding to the DRC is “2457.6 (kbps)”, the estimated communication rate is “819.2(kbps)”. Due to the estimated communication rate, the effect of the other terminals 20 (not shown) connected to the base stations 212 can be considered.

Another example of calculating the estimated communication rate will be described below. When the number of terminals 208 received from the first base station 212a is “8” and the DRC of the first base station 212a derived by the derivation unit 218 is “12”, the estimated communication rate is “307.2 (kbps)”. When the number of terminals 208 received from the first base station 212b is “3” and the DRC of the first base station 212b derived by the derivation unit 218 is “10”, the estimated communication rate is “341.3 (kbps)”. Thus, the base station 212 having the smaller DRC may be selected.

The comparison unit 228 selects the base station 212 having the largest estimated communication rate as a base station to communicate. The control unit 230 controls a timing of the terminal 20 and the like.

This configuration can be implemented in hardware such as CPUs of any computer, memories and LSIs, and in software such as a program having a reservation management function loaded onto the memories. Functional blocks are shown herein with a combination of these. Therefore, those skilled in the art will appreciate that these functions can be implemented in various types such as hardware, software, and a combination of these.

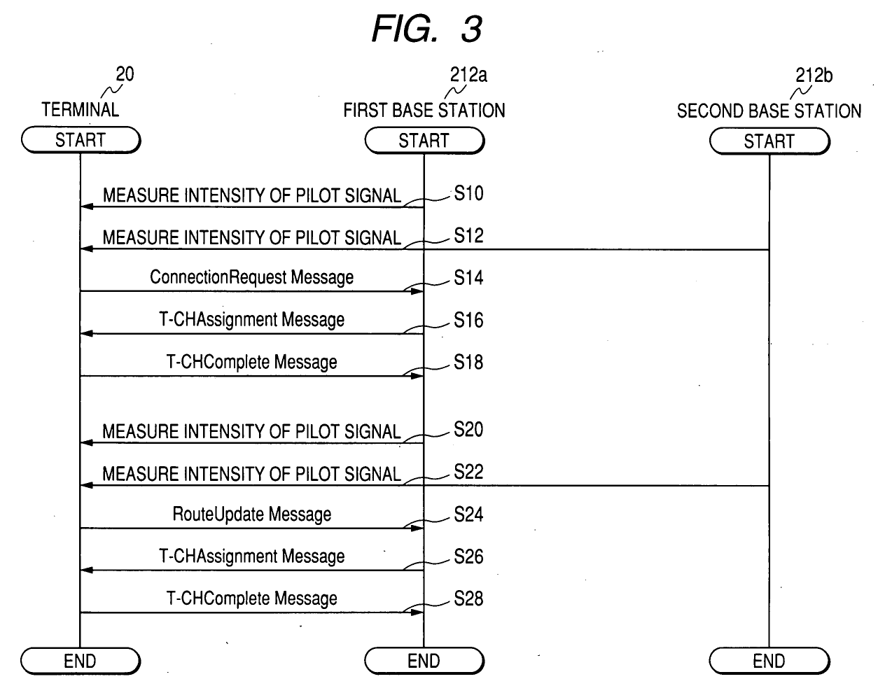

FIG. 3 is a flow chart illustrating a hand-off processing. The flow chart represents a hand-off processing in the EV-DO standard of the embodiment, and is used to show a signal including information about the number of terminals 20 in communication with the base stations 212 described above. The terminal 20 measures the pilot signal intensity from the first base station 212a (S10). Further, the terminal 20 also measures the pilot signal intensity from the second base station 212b (S12). The terminal 20 selects the first base station 212a as a base station to communicate and transmits “Connection Request Message” to the first base station 212a (S14). The first base station 212a transmits “Traffic Channel Assignment Message” to the terminal 20 (S16), and the terminal 20 transmits “Traffic Channel Complete Message” to the first base station 212a (S18), such that the communication link between the terminal 20 and the first base station 212a is established. “the number of the terminals 20 in communication” can be involved in the “Traffic Channel Assignment Message” transmitted from the first base station 212a.

Next, the terminal 20 measures the pilot signal intensity from the first base station 212a (S20). Further, the terminal 20 also measures the pilot signal intensity from the second base station 212b (S22). When the determination unit 234 determines that the terminal 20 can be communicated with the second base station 212b, “Route Update Message” is transmitted in order to inform the first base station 212a of the above determination (S24). The first base station 212a transmits to the terminal 20 “Traffic Channel Assignment Message” that indicates the second base station 212b is available (S26), and the terminal 20 transmits “Traffic Channel Complete Message” to the first base station 212a (S28), such that the communication between the terminal 20 and the second base station 212b is available. “the number of terminals in communication” for the first base station 212a and “the number of terminals in communication” for the second base station 212b can be involved in “Traffic Channel Assignment Message” in step S26.

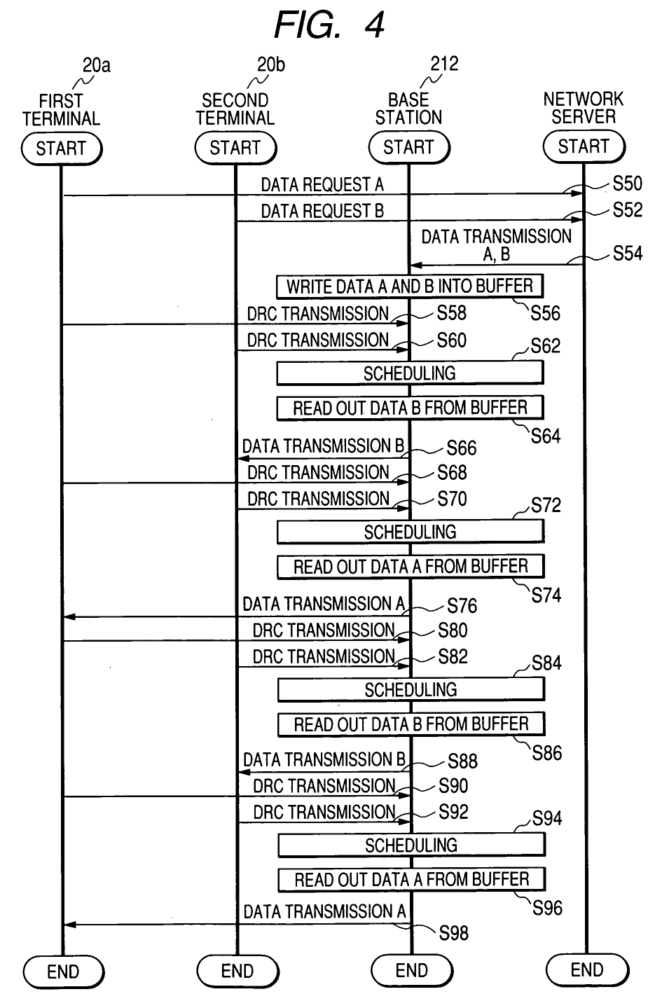

FIG. 4 is a sequence diagram illustrating a TDMA process. The sequence diagram represents the TDMA process for the EV-DO standard of the embodiment, and is used to show a data transmission in the case that the plurality of terminals 20 are connected to one base station 212. Further, assume that there are a first terminal 20a and a second terminal 20b as the terminal 20. The first terminal 20a outputs a data request A to a network server (S50). Further, the second terminal 20b output a data request B to the network server (S52). The network server performs the data transmissions A and B in response to these requests (S54). The base station 212 writes data A and B into a buffer (S56). The first terminal 20a transmits the DRC to the base station 212 (S56), and the second terminal 20b also transmits the DRC to the base station 212 (S58).

As a result, the base station 212 performs scheduling (S62) to determine which terminal 20 is to transmit data. Since the scheduling performed by the base station 212 determines the terminal 20 that is to transmit data, based on the two factors, that is, the DRC of the terminal and the average transmission rate transmitted for a certain previous period, for every 1.66 ms (millisecond), the terminal 20 that performs data transmission is changed in a short interval. The base station 212 reads out the data B from the buffer (S64), and performs data transmission B to the second terminal 20b (S66). The first terminal 20a transmits the DRC to the base station 212 (S68), and the second terminal 20b also transmits the DRC to the base station 212 (S70). The base station 212 performs the scheduling (S72), and the base station 212 reads out the data A from the buffer (S74) and performs data transmission A to the first terminal 20a (S76).

The first terminal 20a transmits the DRC to the base station 212 (S80), and the second terminal 20b also transmits the DRC to the base station 212 (S82) The base station 212 performs the scheduling (S84), reads out the data B from the buffer (S86), and performs the data transmission B to the second terminal 20b (S88). The first terminal 20a transmits the DRC to the base station 212 (S90), and the second terminal 20b also transmits the DRC to the base station 212 (S92). Next, the base station 212 performs the scheduling (S94), reads out the data A from the buffer (S96), and performs the data transmission A to the first terminal 20a (S98). As described above, in the case that the plurality of terminals 20 are connected to the base station 212, the transmission rate is determined not only by the overall wireless environment between the terminal 20 and the base station 212, but also by the other terminal 20.

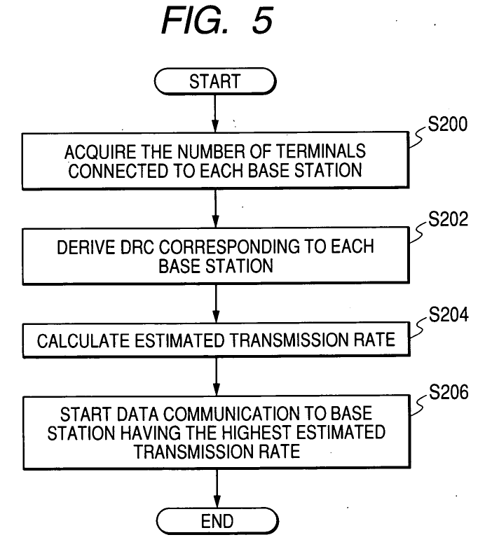

FIG. 5 is a flow chart illustrating a selection process of the base station 212. The acquisition unit 220 acquires the number of terminals 20 connected to each base station 212 (S200). The derivation unit 218 derives the DRC for each base station 212 (S202). The calculation unit 226 calculates an estimated communication rate (S204). The comparison unit 228 selects the base station 212 whose estimated communication rate is highest, and the communication unit 214 starts to communicate data with the selected base station 212 (S206).

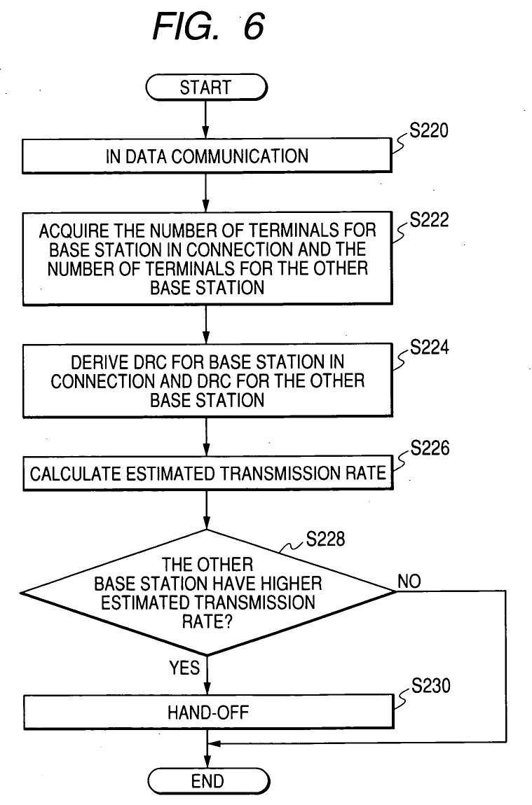

FIG. 6 is a flow chart illustrating a hand-off process. The communication unit 214 is in communication with a base station 212 (S220). The acquisition unit 220 acquires the number of terminals 20 for the base station 212 in connection and the number of terminals for the other base station 212 (S222). The derivation unit 218 derives the DRC for the base station 212 in connection and the DRC for the other base station (S224). The calculation unit 226 calculates the estimated communication rate (S226). When the estimated communication rate for the other base station 212 is higher than that for the base station 212 in connection (Y of S228), the comparison unit 228 determines the hand-off (S230). On the other hand, when the estimated communication rate for the other base station 212 is lower than that for the base station 212 in connection (N of S228), the comparison unit 228 continues the data communication.

According to the embodiment, since the base station to communicate is selected in consideration of the number of terminals as well as the overall wireless environment, the base station having substantially higher communication rate can be selected.

Next, an example, in which a base station 212 is selected when the terminal 20 is in an idle state or establishing a communication channel, will now be described. In order to inform the terminal of the number of terminals 20 connected to the base stations 212, the base station 212 informs the terminal 20 of the number of terminals 20 connected to the base stations 212 included in the notifying information transmitted from the base station 212 during idle state to the terminal 20.

The terminal 20 selects and changes a base station 212 in an idle state based on the number of terminals 20 included in the notifying information (Idle Hand-off). Alternatively, in order to establish the communication channel (Traffic Channel), the base station 212 is selected based on the number of terminals 20 when executing negotiation (Access Hand-off). That is, the terminal 20 always performs the Hand-off for the base station 212 communicating with the smaller number of terminals 20 during idle state, or selects the base station 212 communicating with the smaller number of terminals 20 when establishing the communication channel.

Moreover, in order to increase accuracy, it is preferable to determine a selection of the base station 212 by using the intensity of the pilot signal measured whenever the notification information is received and the DRC derived based on the intensity of the pilot signal. According to the above system, since the base stations 212 are selected in consideration of the number of the terminals 20 connected to the base station 212 during idle state or when establishing the communication channel, a base station 212 expected to be higher communication rate from the start of the communication is determined as a base station to communicate.

The above embodiment is an example, and those skilled in the art will appreciate that a variety of modifications and changes can be made by the combination of each constituent element and each processing process without departing from the scope and spirit of the invention.

In the embodiment “the number of terminals 20 in communication” is included into “Traffic Channel Assignment Message”. However, it is not limited hereto, and a new signal may be defined to transmit, for example, “the number of terminals 20 in communication”. Alternatively, with the “Traffic Channel Assignment Message” transmitted from the base station 212 in communication, “the number of terminals 20 in communication” in other base stations 212 in a vicinity of the base station 212 in communication, may also be transmitted. According to the above also, “the number of terminals 20 in communication” can be informed to the terminal 20. Alternatively, a new dedicated channel may be established. According to the above also, “the number of terminals 20 in communication” can be informed to the terminal 20.

[Second Embodiment]

Next, operation at the time of “hand-over” of a communication terminal according to the invention will be described. A communication system in which the communication terminal is used employs an adaptive modulation system that determines a connection time and a modulation system, based on the DRC from each of the communication terminals connected to the base stations, and is an optimal wireless packet data communication system that performs scheduling and sharing bandwidth in accordance with the number of terminals connected to the same cell.

When the communication terminal is in a situation where quality of communication signals with the base station in communication, e.g., radio wave environment, is degraded to incur hand-over, the communication terminal obtains information on the number of terminals connected to each base station (the number of communication terminals allowed) from a base station in communication and a base station to be a hand-over candidate. The communication terminal estimates the data transmission rate with each of the base stations based on the quality of the receiving signal of the communication terminal and the number of communication terminal in connection. Further, the communication terminal performs hand-over by selecting the base station that can be expected to have an optimum data transmission rate as a base station to communicate.

A second embodiment of the communication terminal of the invention will be described with reference to the drawings.

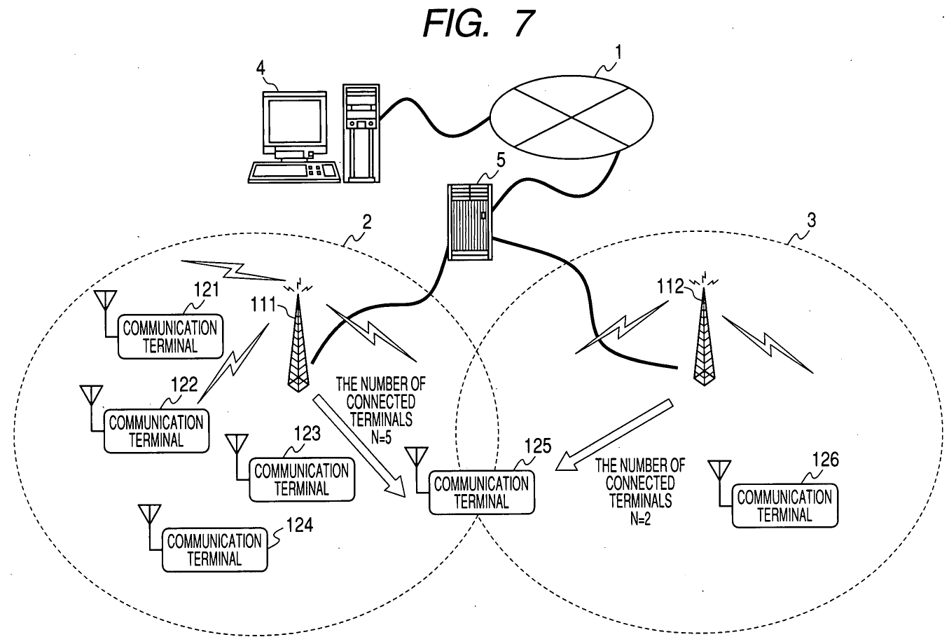

FIG. 7 is a diagram illustrating an exemplary configuration of a wireless packet data communication system in which the communication terminal of the invention is used, showing an example of a video streaming system.

A video streaming server 4 is connected to a wired communication network 1 such as an Internet. The video streaming server 4 transmits contents data encoded by a coding unit such as MPEG-4 to a client terminal such as communication terminals 121 to 126 through the communication network 1. The video streaming server 4 has a variable transmission rate control means that receives feedback information regarding a receiving state from the communication terminals 121 to 126, which are to be clients, and controls a transmission rate from the video streaming server 4 conforming to the receiving state of the communication terminals 121 to 126.

A server 5 functioning as a switching center is arranged between the communication network 1 and wireless networks 2 and 3. The server 5 selects the base stations 111 and 112 that accept the communication terminals 121 to 126 to determine the path of the transmission data. The base stations 111 and 112 transmit and receive information to the communication terminals 121 to 126 in the area via the wireless link. Further, the base stations 111 and 112 receives DRC information from the communication terminal 121 to 126 accepted in the area, and performs a scheduling based on the DRC information. Each of the base stations 111 and 112 has a function of retaining information about the number of currently connected (accepted) communication terminals and transmitting information on “the number of connected (accepted) communication terminals” in response to the request from the communication terminals 121 to 126. FIG. 7 show an example that five communication terminals 121 to 125 are connected (accepted) in the area (wireless network 2) of the first base station 111, and two communication terminals 125 to 126 are connected (accepted) in the area (wireless network 3) of the second base station 112.

The communication terminals 121 to 126 has a function of transmitting and receiving data to/from the base stations 111 and 112, receiving data transmitted from the video streaming server 4, and decoding the received encoded data to display. The communication terminals 121 to 126 monitor the receiving state of data transmitted from the video streaming server 4 and periodically transmit information about the receiving state to the video streaming server 4. Further, the communication terminals 121 to 126 have functions of obtaining information on “the number of connected (accepted) communication terminals” from the connectable base station 111 or 112, and changing the base station 111 or 112 to communicate based on the information on “the number of connected communication terminals” and link quality of downlink (e.g., CIR).

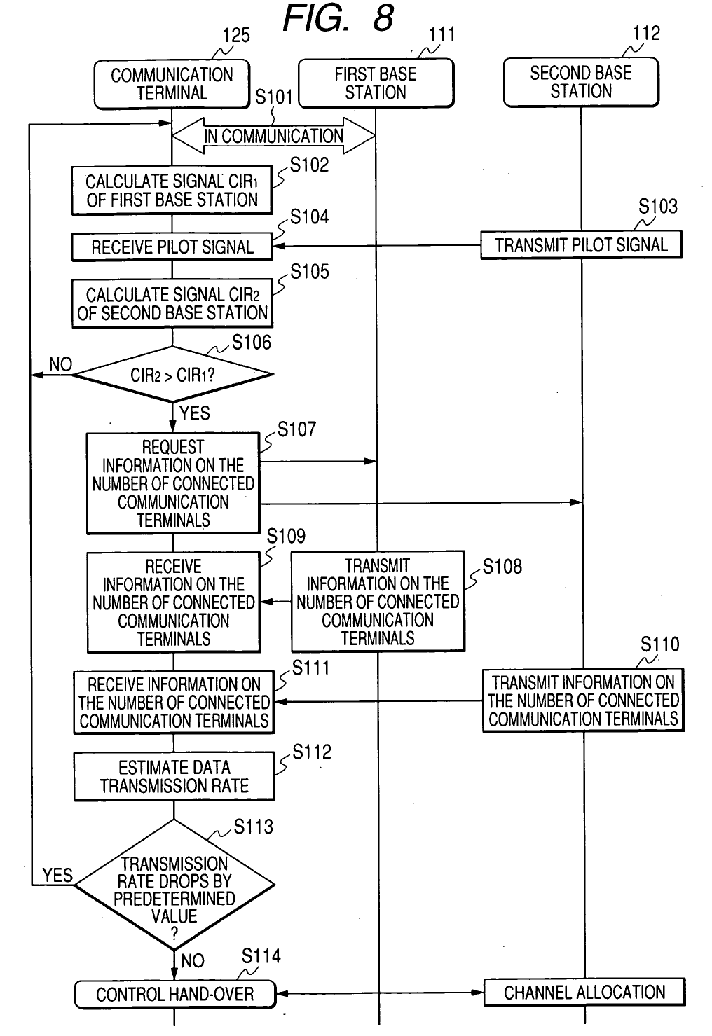

In the system configuration as shown in FIG. 7, a flow of hand-over control will be described with reference to FIG. 8. The communication terminal 125 in the area of the first base station 111 moves toward the area of the second base station 112 while communicating with first base station 111.

The communication terminal 125 is in communication with the first base station 111, and receives video stream data from, for example, the video streaming server 4 (S101).

The communication terminal 125 requires a value of CIR₁ based on the signal received from the first base station 111 currently in communication (S102). Further, the communication terminal 125 receives a pilot signal from the base station capable of receiving the pilot signal (which is the second base station herein), and calculates a value of CIR₂ based on the pilot signal from the second base station 112 (S105), and monitors the value of CIR₂ as well as the value of CIR₁ of the first base station currently in communication.

When the value of CIR₂ calculated for the base station capable of receiving the pilot signal (which is the second base station 112 herein) is larger than the value of CIR₁ (or, when the value of CIR₂ is above threshold value), the second base station 112 is set to a candidate to hand-over, on the ground of hand-over (S106).

When the second base station 112 to be a candidate for the hand-over is detected, the communication terminal 125 requests information on “the number of connected (accepted) communication terminals” to the first base station 111 and the second base station 112 in communication (S107).

The first base station 111 and the second base station 112 that receive “request information on the number of connected communication terminals” from the communication terminal 125 transmit information on “the number of connected (accepted) communication terminals” to the communication terminal 125 (S108 to S111). The communication terminal 125 that has received information on “the number of connected communication terminals” performs estimation of data transmission rate (receipt rate) by using information on “the number of connected communication terminals” obtained from each base station (here, the second base station 112) (S112).

Further, when the data transmission rate, which is estimated from the number of communication terminals in communication with the second base station 112, is estimated not significantly reduced from the current data transmission rate, the hand-over is performed. On the other hand, when the transmission rate, which is estimated from the number of communication terminals in connection with high signal quality, is estimated significantly reduced relative to the current transmission rate, the hand-over is not performed, such that a connection with the first base station 111 is controlled to be maintained (S113 and S114).

That is, signal qualities are compared between the first base station 111 and the second base station 112. When it is estimated that the signal quality for the second base station 112 is high and the data rate estimated from the number of communication terminals in connection is not significantly reduced, the hand-over is performed. On the other hand, when it is estimated that the data transmission rate estimated from the number of communication terminals in connection is high but signal quality is significantly reduced relative to the current transmission rate, the hand-over is not performed and the connection with the first base station 111 is controlled to be maintained.

Regarding the method of transmitting information on “the number of connected communication terminals”, a method of transmitting information by including it in the message periodically informed to each communication terminal, for example, a broadcast message such as “sector parameter message” or “Quick Config Message” in 1× EV-DO can be used, in addition to the method of transmitting information in response to the request from the communication terminal.

Further, the hand-over can be performed by recognizing a type of application in execution at the communication terminal side. For example, as compared the video streaming service with the VoIP, the VoIP is just expected to a relative low data transmission rate, such that the hand-over is available.

Further, the user is informed when the hand-over is performed, and a method of performing the hand-over by user's decision can be used.

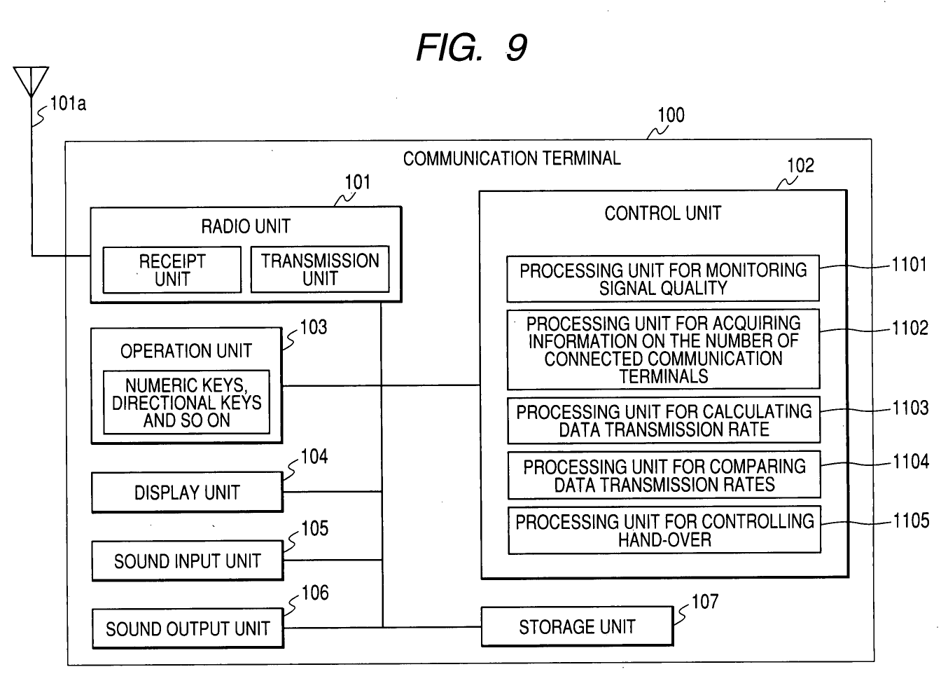

FIG. 9 is a block diagram illustrating a communication terminal of the embodiment. The communication terminal 100 of the embodiment has an antenna 101a and a radio unit 101 including a transmission unit and a receipt unit to be a link interface with a base station, a control unit 102 that controls an overall communication terminal, an operation panel 103 having numeric keys and direction keys and so on, a display unit 104 that displays character data or image data and the like, a sound input unit 105 that receives sound information, a sound output unit 106 that outputs the received sound information, and a storage unit 107 that stores application programs or data files.

The control unit 102 has a processing unit 1101 for monitoring signal quality, a processing unit 1102 for acquiring information on the number of connected communication terminals, a processing unit 1103 for calculating data transmission rate, a processing unit 1104 for comparing data transmission rates, and a processing unit 1105 for controlling hand-over, as essential component for the invention.

The processing unit 1101 for monitoring signal quality calculates a CIR value based on a pilot signal obtained from each base station to be a hand-over candidate, and monitors (compares) the CIR value of the base station to be the hand-over candidate and the CIR value of the base station currently in communication. The processing unit 1102 for acquiring information on the number of connected communication terminals requests transmission of information on “the number of connected communication terminals (the number of accepted communication terminals)” to the base station currently in communication and the base station to be the hand-over candidate, and then acquires the information on “the number of connected communication terminals”.

The processing unit 1103 for calculating a data transmission rate calculates an estimated data transmission rate with each of the base stations, based on the information on “the number of connected communication terminals (the number of accepted communication terminals)” obtained from each base station to be the hand-over candidate. The processing unit 1104 for comparing data transmission rates compares the estimated data transmission rates obtained in the processing unit 1103 for calculating the data transmission rate to determine whether or not hand-over control is needed and which base station is to be a target for hand-over. The processing unit 1105 for controlling hand-over performs hand-over control used to perform a channel connection with the base station to be a target for hand-over.

While the invention has been described with reference to exemplary embodiments, the communication terminal of the present invention is not restrictive hereto, and a variety of modifications and changes can be made without departing from the scope and spirit of the present invention.

1. A communication terminal comprising:
a derivation portion that derives estimated transmission rate with each of a plurality of base stations which are available to communicate with the communication terminal, based on signals transmitted from the base stations;
a reception portion that receives the number of terminals being connected to each base station from any of the base stations; and
a control portion that selects a base station to communicate among the base stations based on the derived estimated transmission rate and the received number of terminals.

2. The communication terminal according to claim 1,
wherein the number of terminals received by the reception portion includes the number of terminals in communication with each of the base stations.

3. The communication terminal according to claim 2,
wherein the number of terminals received by the reception portion further includes the number of terminals in an idle state for each of the base stations.

4. The communication terminal according to claim 1,
wherein the control portion, for each of the base stations, calculates the number of terminals in execution based on the received number of terminals and the derived estimated transmission rate, and then calculates a transmission rate by the number of terminals in execution, and compares each of the calculated transmission rates to select a base station corresponding to the highest transmission rate as a base station to communicate.

5. The communication terminal according to claim 1,
wherein the control portion selects a base station to communicate among the base stations in a case of transmitting signals.

6. The communication terminal according to claim 1, further comprising:
a storage portion that stores the derived estimated transmission rate and the received number of terminals,
wherein the control portion selects a base station to communicate among the base station, based on the estimated transmission rate and the number of terminals stored in the storage portion.

7. A base station selection method comprising the steps of:
deriving estimated transmission rate with each of a plurality of base stations which are available to communicate with the communication terminal, based on signals transmitted from the base stations;
receiving the number of terminals being connected to each base station from any of the base stations; and
selecting a base station to communicate among the base stations based on the derived estimated transmission rate and the received number of terminals.

8. A communication terminal, which changes a base station to communicate by hand-over between a plurality of base stations, comprising:
a measuring portion that measures quality of communication with a base station in communication and quality of communication with a base station to be a hand-over candidate;
a reception portion that receives the number of terminals being connected to the base station in communication and the number of terminals being connected to the base station to be the hand-over candidate; and
a control portion that determines whether or not a hand-over is needed or a base station to be a hand-over target among the base stations to be the hand-over candidate, based on the measured communication qualities and the received number of terminals.

9. The communication terminal according to claim 8,
wherein the control portion calculates a transmission rate with each of the base stations based on the received number of terminals, compares the calculated transmission rate with each base station, and determines whether or not hand-over is needed or a base station to be a hand-over target according to a comparison result.

10. The communication terminal according to claim 8,
wherein the control portion determines whether or not a hand-over is needed or a base station to be a hand-over target, based on the measured communication qualities, the received number of terminals and a type of application in execution.
